(19) United States
(12) Patent Application Publication
(10) Pub. No.: US 2015/0168810 A1
(43) Pub. Date: Jun. 18, 2015

(54) RAPID AUTO-FOCUSING APPARATUS AND METHOD

(71) Applicant: ELECTRONICS AND TELECOMMUNICATIONS RESEARCH INSTITUTE, Daejeon (KR)

(72) Inventor: Chan-Ho JUNG, Daejeon (KR)

(21) Appl. No.: 14/308,626

(22) Filed: Jun. 18, 2014

(30) Foreign Application Priority Data
Dec. 13, 2013 (KR) 10-2013-0155869

(51) Int. Cl. G03B 13/36; G06T 3/00; H04N 5/232

(52) U.S. Cl. CPC G03B 13/36; H04N 5/23212; G06T 3/00

(57) ABSTRACT

Disclosed herein is an auto-focusing method by a rapid auto-focusing apparatus, including: extracting, by an image loading module, an input image for auto-focusing; transforming, by an image transforming module, the extracted input image into a binary image; calculating, by a focus value calculating module, a focusing degree at each lens position by performing a binary operation on some or all of the pixels of the binary image; and receiving, by a lens moving module, a control value for the calculated focusing degree to move a lens, thereby positioning the lens at an accurate focus position.

### CROSS REFERENCE TO RELATED APPLICATION

This application claims the benefit of Korean Patent Application No. 10-2013-0155869 filed on, 2013, entitled “Rapid Auto-focusing Apparatus and Method”, which is hereby incorporated by reference in its entirety into this application.

### BACKGROUND OF THE INVENTION

1. Technical Field

The present invention relates to a rapid auto-focusing apparatus and method of a camera module using a binary image.

2. Description of the Related Art

An auto-focusing apparatus auto-focuses a lens on a subject while physically moving the lens, in a camera module mounted in a mobile communication terminal, a vision inspecting apparatus for inspecting and measuring an object, an electron microscope, and the like.

Recently, an auto-focusing function of auto-focusing the lens on the subject has been provided to an imaging device such as a camera for convenience of a user.

In the camera module, a focusing speed is one of the core technology elements determining a reliability of a product.

As the auto-focusing method, a through-the-lens (TTL) auto-focusing method using light incident through an imaging lens is mainly used. As the auto-focusing method, there are a contrast detection method, a phase difference detection method, and the like.

According to the related art, a focusing degree is calculated in each lens position in order to detect an accurate position of each lens. The focusing degree is determined by a sharpness value of a luminance channel I.

According to the related art, a method of using a luminance value itself without separately processing the luminance value when calculating the focusing degree is used as one of the auto-focusing methods.

In this method, the focusing degree is calculated by the following Equation 1, and four fundamental arithmetic operations between 8-bit values having values between 0 and 255 are required for all pixels of an input image.

f=Σ(|Iₓ−Iₓ₊₁|+|I_{y}−I_{y+1}|)

Korean Patent Laid-Open Publication No. 10-2013-0029681 has disclosed an apparatus of calculating a focusing degree using all the pixels of the input image as described above.

### RELATED ART DOCUMENT

### Patent Document

(Patent Document 1) Korean Patent Laid-Open Publication No. 10-2013-0029681 (Auto-focusing apparatus)

### SUMMARY OF THE INVENTION

An object of the present invention is to provide an auto-focusing apparatus and method of a camera module capable of increasing a focusing speed using a binary image.

According to an exemplary embodiment of the present invention, there is provided a rapid auto-focusing apparatus including: an image loading module extracting an input image for auto-focusing; an image transforming module transforming the input image input through the image loading module into a binary image; a focus value calculating module calculating a focusing degree at each lens position by performing a binary operation on some or all of the pixels of the binary image transformed by the image transforming module; a lens moving module receiving a control value calculated by the focus value calculating module to move a lens forward and backward, thereby allowing the lens to be positioned at a predetermined focus position; and a controlling unit generating a control signal controlling the image loading module, the image transforming module, the focus value calculating module, and the lens moving module to position the lens at an accurate focus position.

The image transforming module may extract a 8^{th} bit, which is the most significant bit (MSB), for each pixel of the input image input through the image loading module to transform the input image into the binary image.

The focus value calculating module may calculate a focus value through a binary operation between neighboring pixels for each pixel in the binary image.

The focus value calculating module may calculate the focus value by the following Equation:

$$F = {\sum }_{i = 1}^{M} {\sum }_{j = 1}^{N - 1} b ( i , j + 1 ) ⊕ b ( i , j )$$

where F indicates a focus value, b(i, j) indicates a transformed binary value image, and ⊕ indicates an exclusive-OR operation.

The 8^{th} bit may be a binary image in which an amount of image data is decreased while including focus information on the input image as much as possible as compared with other bits.

According to another exemplary embodiment of the present invention, there is provided an auto-focusing method by a rapid auto-focusing apparatus, including: extracting, by an image loading module, an input image for auto-focusing; transforming, by an image transforming module, the extracted input image into a binary image; calculating, by a focus value calculating module, a focusing degree at each lens position by performing a binary operation on some or all of the pixels of the binary image; and receiving, by a lens moving module, a control value for the calculated focusing degree to move a lens, thereby positioning the lens at an accurate focus position.

### BRIEF DESCRIPTION OF THE DRAWINGS

FIG. 1 is a diagram showing a configuration of an auto-focusing apparatus of a camera module according to an exemplary embodiment of the present invention;

FIG. 2 is a flow chart showing an auto-focusing method according to an exemplary embodiment of the present invention;

FIGS. 3A and 3B show a binary image transformed from an input image according to an exemplary embodiment of the present invention;

FIG. 4 shows extraction of a transformed 8^{th} 1-bit plane;

FIG. 5 shows a 1-bit binary image transformed from an input image;

FIG. 6 shows a normalized focus value depending on a focus motor position according to an exemplary embodiment of the present invention and focus values by focusing methods according to the related art;

FIG. 7 is a graph for comparing an error of a motor position by a focusing method according to an exemplary embodiment of the present invention and errors of motor positions by the focusing methods according to the related art with each other;

FIG. 8 is a graph for comparing an accuracy of the motor position by the focusing method according to an exemplary embodiment of the present invention and accuracies of the motor positions by the focusing methods according to the related art with each other; and

FIG. 9 is a graph for comparing operation times of the focusing method according to an exemplary embodiment of the present invention and the focusing methods according to the related art with each other.

FIG. 10 illustrates how the apparatus for controlling auto-focusing in accordance with an embodiment of the present invention is embodied in the form of a computer system.

### DESCRIPTION OF THE EXEMPLARY EMBODIMENTS

The present invention may be variously modified and have several forms. Therefore, specific exemplary embodiments of the present invention will be illustrated in the accompanying drawings and be described in detail in the present specification. However, it is to be understood that the present invention is not limited to a specific exemplary embodiment, but includes all modifications, equivalents, and substitutions without departing from the scope and spirit of the present invention. When it is determined that the detailed description of the known art related to the present invention may obscure the gist of the present invention, the detailed description thereof will be omitted.

Exemplary embodiments of the present invention will be described with reference to the accompanying drawings.

Terms used in the specification, ‘first’, ‘second’, etc., may be used to describe various components, but the components are not to be interpreted to be limited to the terms. The terms are used to distinguish one component from another component.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts mentioned in this specification, or a combination thereof, but do not preclude the presence or addition of one or more other features, numerals, steps, operations, components, parts, or a combination thereof.

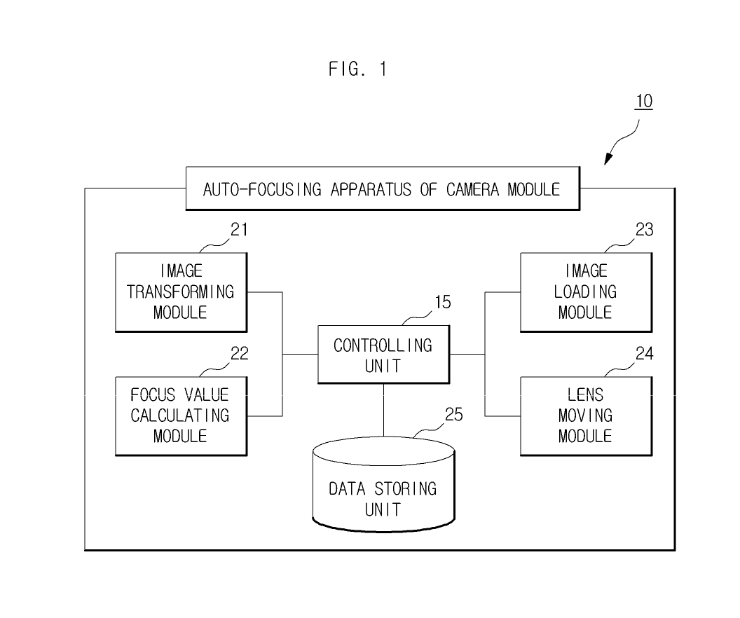

FIG. 1 is a diagram showing a configuration of an auto-focusing apparatus of a camera module according to an exemplary embodiment of the present invention.

Referring to FIG. 1, the auto-focusing apparatus 10 according to an exemplary embodiment of the present invention is configured to include an image loading module 23, an image transforming module 21, a lens moving module 24, a controlling unit 15, a focus value calculating module 22, and a data storing unit 25.

The controlling unit 15 performs a series of processes controlling the respective module unit of the auto-focusing apparatus to detect accurate positions of lenses.

The image loading module loads an input image for auto-focusing.

The lens moving module 24 moves the lens forward and backward by a control signal of the controlling unit 15 to allow the lens to be positioned at an accurate focus position.

The image transforming module 21 transforms the input image input through the image loading module 23 into a binary image.

The focus value calculating module 22 calculates a focusing degree at each lens position, using a binary operation for some or all of the pixels of the binary image transformed by the image transforming module 21.

The data storing unit 25 stores a reference data and a calculated data depending on an auto-focusing process of each module.

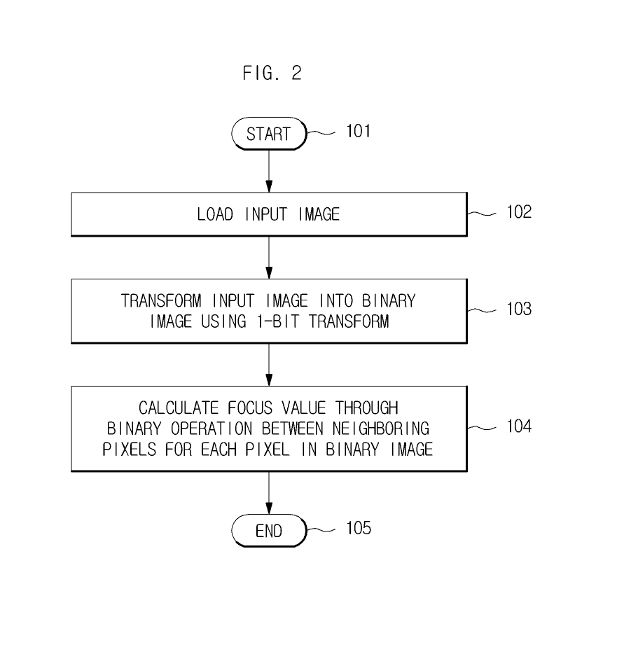

FIG. 2 is a flow chart showing an auto-focusing method according to an exemplary embodiment of the present invention.

In the auto-focusing method according to an exemplary embodiment of the present invention, an operation between 8-bits is not required in calculating a focus value.

According to an exemplary embodiment of the present invention, the image loading module 23 first loads an input image data for which a focusing degree is to be calculated (step 102).

Next, the image transforming module 21 receives the loaded input image and transforms the input image into a binary image.

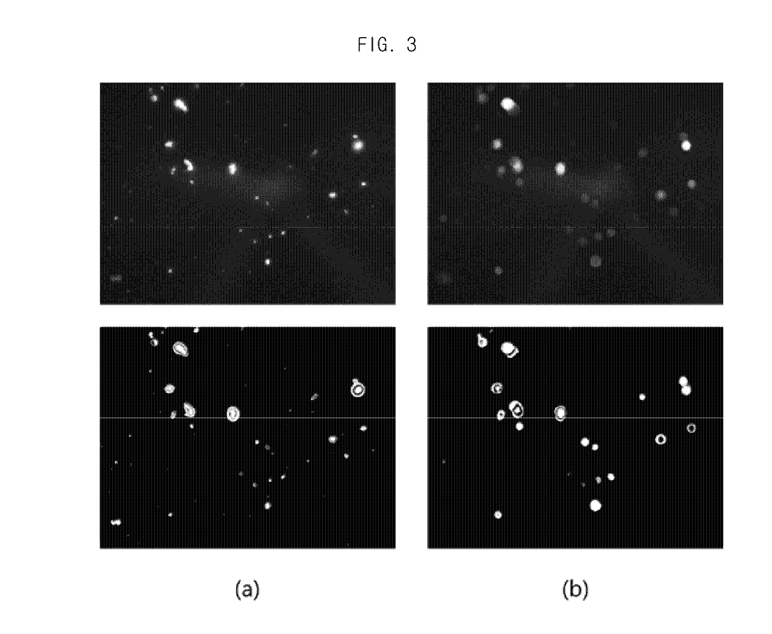

FIGS. 3A and 3B show a binary image transformed from an input image according to an exemplary embodiment of the present invention.

Referring to FIGS. 3A and 3B, in FIG. 3A showing an image that is accurately focused, an upper image indicates an input image, and a lower image indicates a binary image.

FIG. 3B shows an image that is not accurately focused.

According to an exemplary embodiment of the present invention, a 8-bit grayscale image is calculated as a 8^{th} 1-bit plane for the most significant bit (MSB).

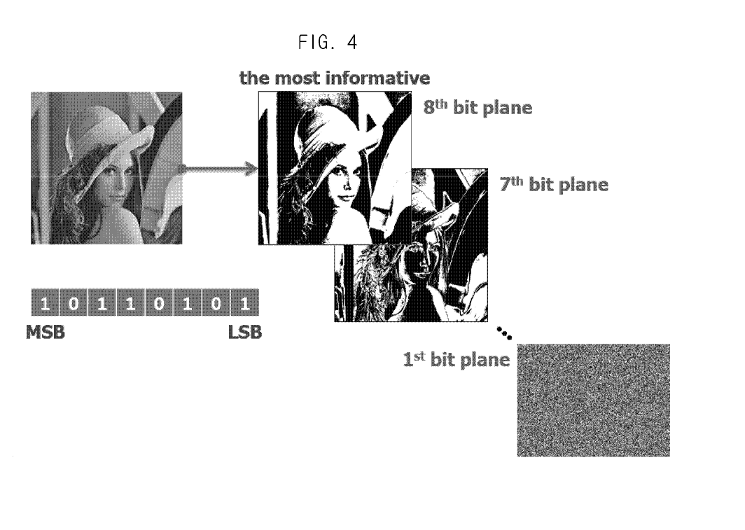

FIG. 4 shows extraction of a transformed 8^{th} 1-bit plane.

Referring to FIG. 4, this 8^{th} 1-bit plane shows a binary image in which an amount of image data is decreased while including focus information as much as possible.

According to an exemplary embodiment of the present invention, a 8^{th} bit (most significant bit) may be extracted for each pixel to very simply create a binary image and calculate a focus value using the binary operation.

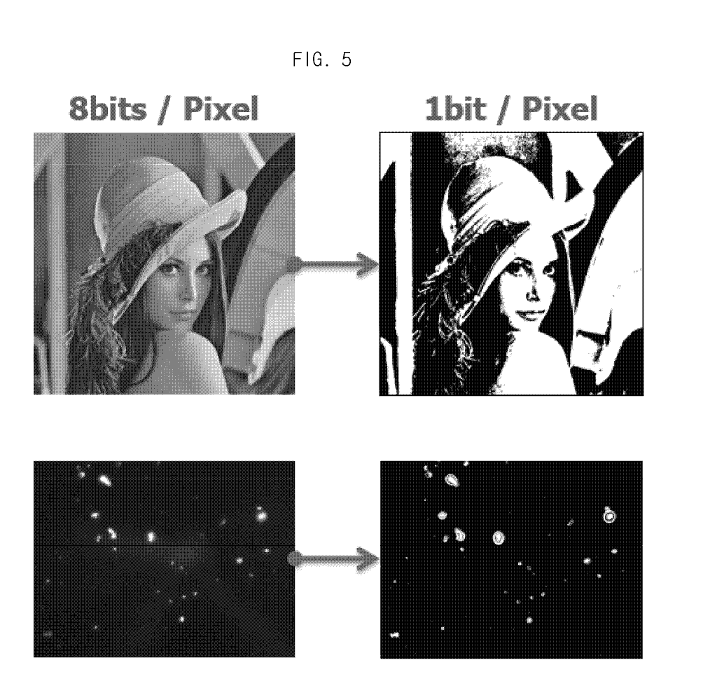

FIG. 5 shows a 1-bit binary image transformed from an input image.

Referring to FIG. 5, it may be appreciated that a 1-bit transformed image according to an exemplary embodiment of the present invention clearly includes focus information of an actual 8-bit image.

According to an exemplary embodiment of the present invention, the input image is transformed into the 1-bit image using the Boolean operator.

Next, in step 104, the focus value calculating module 22 calculates the focus value through a binary operation between neighboring pixels for each pixel in the binary image.

The focus value as described above is calculated by the following Equation 2.

$$F = {\sum }_{i = 1}^{M} {\sum }_{j = 1}^{N - 1} b ( i , j + 1 ) ⊕ b ( i , j ) \qquad [ Equation 2 ]$$

Here, F indicates a focus value, and b(i, j) indicates a transformed binary value image. ⊕ indicates an exclusive-OR operation.

In an exemplary embodiment of the present invention, rapid auto-focusing may be performed by simple implementation using a concept of a bit plane of a digital discrete signal.

Then, the controlling unit moves the lens to an accurate focus position by the lens moving module 24 depending on the calculated focus value to perform the focusing.

In the values transformed as described above, multiplication square, trigonometric function operation convolution, or the like, between 8-bit values as in the related art is not required, such that an operation may be rapidly performed.

A sharpness of an image according to an exemplary embodiment of the present invention is measured by calculating an intensity difference between two continuous pixels. That is, an exclusive-OR operation between two continuous binary value pixels is performed to measure the sharpness of the image.

The present invention has been tested using a dataset of sputum smear fluorescence images (http://biig.uc3m.es/autofocus_stacks/of URL) published in order to verify exemplary embodiment of the present invention. A data set includes 300 image stacks, and an image was acquired using an automatic setting function (that is, an automated fluorescence microscope in which a focus is controlled).

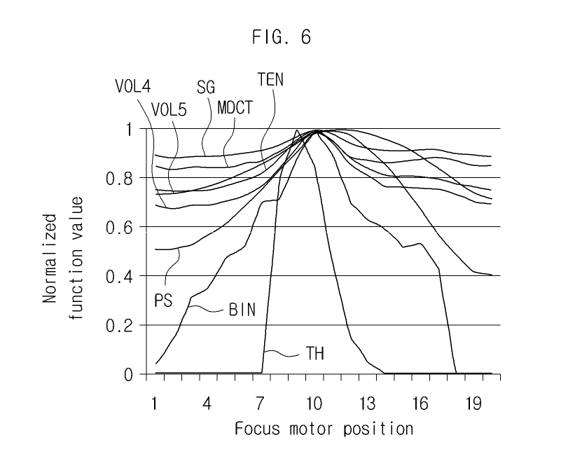

FIG. 6 shows a normalized focus value depending on a focus motor position according to an exemplary embodiment of the present invention and focus values by focusing methods according to the related art.

In FIG. 6, an accurate position of a focus is 10.

Referring to FIG. 6, it may be appreciated that a reliability of focusing according to an exemplary embodiment of the present invention is 10, which is the accurate position of the focus.

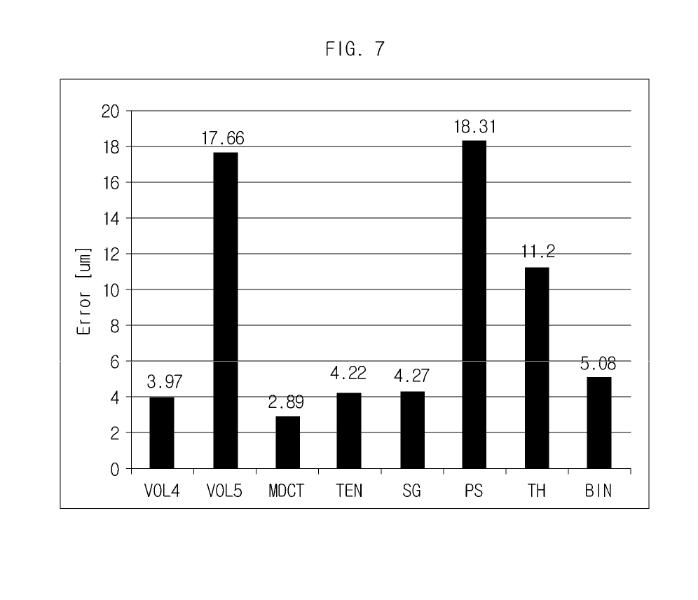

FIG. 7 is a graph for comparing an error of a motor position by a focusing method according to an exemplary embodiment of the present invention and errors of motor positions by the focusing methods according to the related art with each other.

It may be appreciated that the position error of the motor by the focusing method BIN according to an exemplary embodiment of the present invention is 5.08 μm, which is equal to or smaller than an average distribution of the errors of the motor positions by the focusing methods according to the related art.

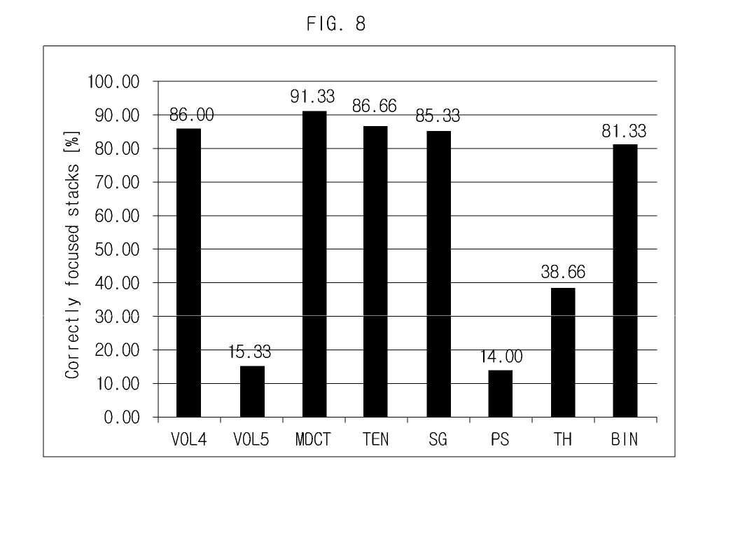

FIG. 8 is a graph for comparing an accuracy of the motor position by the focusing method according to an exemplary embodiment of the present invention and accuracies of the motor positions by the focusing methods according to the related art with each other.

Referring to FIG. 8, it may be appreciated that a reliability of auto-focusing by the focusing method BIN according to an exemplary embodiment of the present invention is similar to those of the auto-focusing by the focusing methods VOL4, MDCT, TEN, and SG according to the related art.

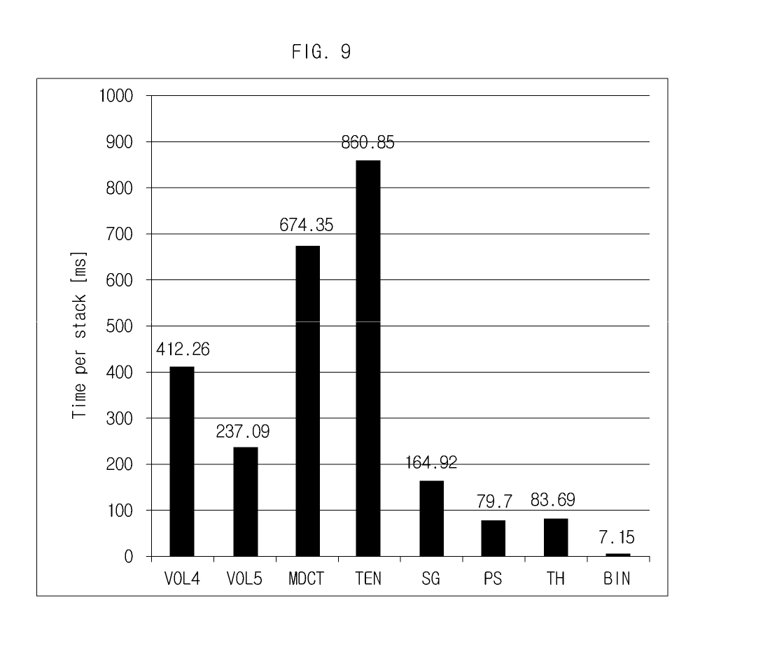

FIG. 9 is a graph for comparing operation times of the focusing method according to an exemplary embodiment of the present invention and the focusing methods according to the related art with each other.

Referring to FIG. 9, it may be appreciated that the operation time of the focusing method according to an exemplary embodiment of the present invention is 7.15 ms, which is significantly more rapid than those of the focusing methods according to the related art.

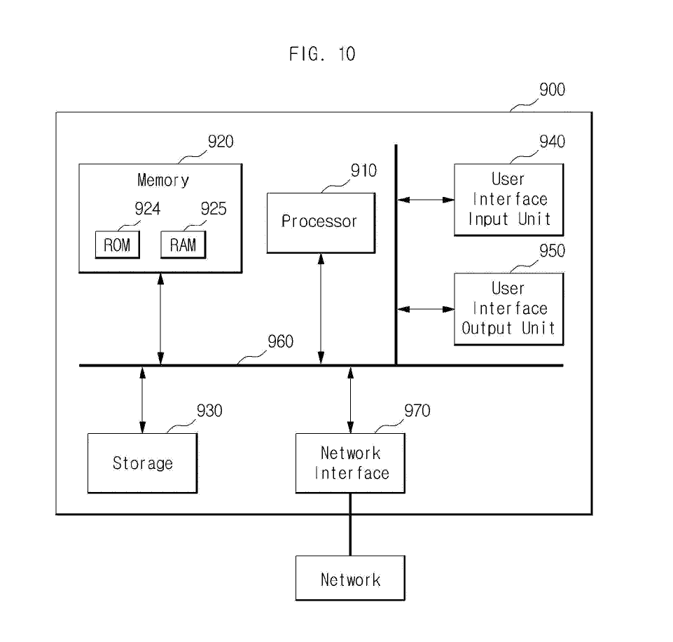

FIG. 10 illustrates how the apparatus for controlling auto-focusing in accordance with an embodiment of the present invention is embodied in the form of a computer system.

The above-described auto-focusing control apparatus 120 may be implemented in a computer system, e.g., as a computer readable medium. As shown in FIG. 6, a computer system 900 may include one or more of a processor 910, a memory 920, a user interface input unit 940, a user interface output unit 950, and a storage 930, each of which communicates through a bus 960. The computer system 900 may also include a network interface 970 that is coupled to a network. The processor 910 may be a central processing unit (CPU) or a semiconductor device that executes processing instructions stored in the memory 920 and/or the storage 930. The memory 920 and the storage 930 may include various forms of volatile or non-volatile storage media. For example, the memory may include a read-only memory (ROM) 924 and a random access memory (RAM) 925.

The auto-focusing method according to an exemplary embodiment of the present invention may have an accuracy and a reliability that are the same as those of the focusing method according to the related art including a 8-bit operation and may have a focusing operation speed significantly more rapid than that of the focusing method according to the related art.

What is claimed is:

1. A rapid auto-focusing apparatus comprising:
an image loading module extracting an input image for auto-focusing;
an image transforming module transforming the input image input through the image loading module into a binary image;
a focus value calculating module calculating a focusing degree at each lens position by performing a binary operation on some or all of the pixels of the binary image transformed by the image transforming module;
a lens moving module receiving a control value calculated by the focus value calculating module to move a lens forward and backward, thereby allowing the lens to be positioned at a predetermined focus position; and
a controlling unit generating a control signal controlling the image loading module, the image transforming module, the focus value calculating module, and the lens moving module to position the lens at an accurate focus position.

2. The rapid auto-focusing apparatus of claim 1, wherein the image transforming module extracts a 8^{th} bit, which is the most significant bit (MSB), for each pixel of the input image input through the image loading module to transform the input image into the binary image.

3. The rapid auto-focusing apparatus of claim 2, wherein the focus value calculating module calculates a focus value through a binary operation between neighboring pixels for each pixel in the binary image.

4. The rapid auto-focusing apparatus of claim 3, wherein the focus value calculating module calculates the focus value by the following Equation:
$$F = {\sum }_{i = 1}^{M} {\sum }_{j = 1}^{N - 1} b ( i , j + 1 ) ⊕ b ( i , j )$$
where F indicates a focus value, b(i, j) indicates a transformed binary value image, and ⊕ indicates an exclusive-OR operation.

5. The rapid auto-focusing apparatus of claim 2, wherein the 8^{th} bit is a binary image in which an amount of image data is decreased while including focus information on the input image as much as possible as compared with other bits.

6. An auto-focusing method by a rapid auto-focusing apparatus, comprising:
extracting, by an image loading module, an input image for auto-focusing;
transforming, by an image transforming module, the extracted input image into a binary image;
calculating, by a focus value calculating module, a focusing degree at each lens position by performing a binary operation on some or all of the pixels of the binary image; and
receiving, by a lens moving module, a control value for the calculated focusing degree to move a lens, thereby positioning the lens at an accurate focus position.

7. The auto-focusing method of claim 6, wherein in the transforming, a 8^{th} bit, which is the MSB, is extracted for each pixel of the input image input through the image loading module to transform the input image into the binary image.

8. The auto-focusing method of claim 7, wherein in the calculating, the focus value calculating module calculates a focus value through a binary operation between neighboring pixels for each pixel in the binary image.

9. The auto-focusing method of claim 8, wherein the focus value is calculated by the following Equation:
$$F = {\sum }_{i = 1}^{M} {\sum }_{j = 1}^{N - 1} b ( i , j + 1 ) ⊕ b ( i , j )$$
where F indicates a focus value, b(i, j) indicates a transformed binary value image, and ⊕ indicates an exclusive-OR operation.

10. The auto-focusing method of claim 7, wherein the 8^{th} bit is a binary image in which an amount of image data is decreased while including focus information on the input image as much as possible as compared with other bits.
